(19) United States
(12) Patent Application Publication
(10) Pub. No.: US 2002/0103659 A1
(43) Pub. Date: Aug. 1, 2002

(54) Electronic appliance capable of displaying right or certification given from public organization

(75) Inventor: Yoshito Katagiri, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 09/995,727

(22) Filed: Nov. 29, 2001

(30) Foreign Application Priority Data
Dec. 1, 2000 (JP) 366834/2000

(51) Int. Cl. G06F 17/60

(52) U.S. Cl. 705/1

(57) ABSTRACT

An electronic appliance, comprises an input section to input information regarding at least one of a right and a certification given from a predetermined public organization; a memory section to memorize the information inputted by the inputted section; an output section to output the information memorized in the memory section as information concerning the electronic appliance; and a control section to control the input section, the memory section and the output section.

### BACKGROUND OF THE INVENTION

The present invention relates to an electronic appliance by which display or printing of the information about the right or certification given from the predetermined public organization (authority) can be conducted, and a system by which the renewal of the information is conducted, recording medium, and in more detail, relates to an electronic appliance by which the display or printing of the information relating to the intellectual property such as the patent right, or the right of utility model, can be conducted, and a system for its renewal, and recording medium.

When the patent relating to a technology adopted in a product is applied, it is conducted conventionally that the information of the patent application number given from the patent office or patent registration number, or the information showing that the patent is applied, is displayed on the corresponding product or its package member, and for example, on a portion of the outer package surface of the corresponding product, a note such as [on patent application], [PATENT PENDING], or [JPNo. ______] is displayed. Thereby, it shows that the corresponding product is protected by the patent right, and aims that the production of the imitation by the third person is given up.

In this connection, when the information about the intellectual property is displayed on the product or package member, conventionally, printing, stamping, or seal sticking on the product or package member is conducted.

However, the information about the intellectual property is changed with a lapse of time, and as an example, it sometimes changes from the stage on patent application to the stage of registration, or the right sometimes can not be given due to the reason such as the existence of the related art. Further, even when the right can be given, the right is extinguished in the future with various reasons such as the expiration of term of right or others. Further, corresponding to countries to which the product is exported, there is sometimes a case in which it is necessary that the display content of the information about the intellectual property is changed.

As an example, after the product on which a note that the patent is on filing is displayed, is shipped from a factory, it is stocked in a branch office, and when the patent registration number is given before the product is delivered to the user, as the newest information, it is desirable that the display is changed to [patent registration No. ______]. Further, when the right can not be given to the patent application which is pending, or when it is registered, but the right is extinguished due to the expiration of term of the right, it is desired that the display of such the information is not conducted. Although the right does not exist, it is a display of the false that the display is conducted on as if the right exists.

In this connection, when the information about the intellectual property is displayed by the printing or stamping as conventionally, the display content can not easily be changed, and at the utmost the new display seal can only be stuck on the displayed portion. However, when the man-hour of the seal making or sticking operation is considered, such the display content change is the high cost and troublesome operation, therefore, in manufacturers, there is a tendency that they hesitate in conducting the display of the information about the intellectual property such as the patent registration number.

Further, in the case where the products are shipped to a plurality of countries, when the information about the intellectual property is displayed by printing or stamping, in the case where the content of the patent application is different for each country, because it is necessary that the display content of the product is changed for each different shipping country, the production efficiency is very bad. Further, although there is a case where the shipped country of the product which remains as a stock in the warehouse due to the change of sales condition is changed, also in this case, there is no more countermeasure than the seal on which a new content is displayed, is only stuck on such the display.

In this connection, after the product is delivered to the user, even when the information about the intellectual property is changed, it is generally difficult to cope with it, but in the case where, for example, it is a product for which a service man periodically visits the user and the maintenance work is conducted, as conducted for a user who purchases or rents a copier or printer, even after it is delivered to the user, the old display can be changed to a new one. However, even in this case, when such the change operation is not easily conducted, the possibility that the display is left on as the display change is not conducted, becomes high.

### SUMMARY OF THE INVENTION

In view of such the problems, the present invention is attained, and the object of the present invention is to propose an electronic appliance, system, and recording medium by which the information about the right or certification given from the predetermined public organization can be easily displayed in not only a factory, but also in a branch office, and when it is necessary that this information is changed, it can be easily renewed from the old information to the new information and displayed. Further, in addition to the above description, another object of the present invention is that the information is carelessly not erased, and freely not altered by the third person, and the reliability of the display content is enhanced.

The above objects can be attained by any one of the following structures.

(1) An electronic appliance, comprises:

an input section to input information regarding at least one of a right and a certification given from a predetermined public organization;

a memory section to memorize the information inputted by the input section;

an output section to output the information memorized in the memory section as information concerning the electronic appliance; and

a control section to control the input section, the memory section and the output section.

(2) In the electronic appliance of (1), the output section is at least one of a display section to display the information and a printing section to print the information.

(3) In the electronic appliance of (1), the input section is at least one of a communicating device to communicate with an external device and a reading device to read information recorded in a predetermined recording medium.

(4) In the electronic appliance of (1), the control section renews the information memorized in the memory section.

(5) In the electronic appliance of (4), the control section renews the information by adding and recording new information capable of being inputted by the input section.

(6) In the electronic appliance of (4), the control section conducts judgment on the basis of at least one of a renewal date and version information included in the information memorized in the memory section.

(7) In the electronic appliance of (3), the control section conducts authentication with the external device or with the predetermined recording medium before the inputting section inputs the information, and only when the control section confirms the authentication, the control section controls the input section to input the information from the external device or the predetermined recording medium.

(8) In the electronic appliance of (1), the output section outputs the information based on an operation to turn on or off a power source of the electronic appliance.

(9) In the electronic appliance of (1), the output section keeps on outputting the information for a predetermined time period.

(10) In the electronic appliance of (1), the one of the right and the certification given from the predetermined public organization is an intellectual property right given from a Patent Office.

(11) In the electronic appliance of (1), the information includes information regarding a country in which an application was filed and the control section controls the output section to output the information regarding the country.

(12) In the electronic appliance of (10), further comprising:

an eliminating section to eliminate the information memorized in the memory section; or

an prohibit section to prohibit the output section to output the information memorized in the memory section.

(13) In the electronic appliance of (1), further comprising:

a calendar section having data of a date, wherein the control section judged whether an expiration date of the intellectual property has passed over or not based on the data of a date, and when the expiration date of the intellectual property has passed over, the control section controls the eliminating section so as to eliminate the information and/or the prohibit section so as to prohibit the output section to output the information.

(14) A system, comprises:

a transmitting terminal to transmit information regarding at least one of a right and a certification given from a predetermined public organization to a network; and

a receiving terminal to receive the information through the network, the receiving terminal having

a communicating section to receive the information,

a memory section to memorize the information received by the communicating section;

an output section to output the information memorized in the memory section as information concerning the receiving terminal; and

a control section to control the communicating section, the memory section and the output section,

wherein the control section renews the information stored in the memory section.

(15) In the system of (14), the output section is at least one of a display section to display the information and a printing section to print the information.

(16) In the system of (14), the control section judges whether or not conducting renewing the information on the basis of at least one of a renewal date and version information included in the information memorized in the memory section.

(17) In the system of (14), the control section conducts authentication between the transmitting terminal and the receiving terminal before the transmitting terminal transmits the information, and when the control section confirms the authentication, the transmitting terminal transmits the information and the receiving terminal receives the information.

(18) In the system of (14), the one of the right and the certification given from the predetermined public organization is an intellectual property right given from a Patent Office.

Further, the above objects may be attained by the following preferable structures.

(2-1) An electronic appliance, comprises:

an input section to input information regarding at least one of a right and a certification given from a predetermined public organization;

a memory section to memorize the information inputted by the inputted section;

an output section to output the information memorized in the memory section; and

a control section to control the input section, the memory section and the output section.

(2-2) In the electronic appliance of (2-1), the output section is at least one of a display section to display the information and a printing section to print the information.

(2-3) In the electronic appliance of (2-1) or (2-2), the input section is at least one of a communicating device to communicate with an external device and a reading device to read information recorded in a predetermined recording medium.

(2-4) In the electronic appliance of one of (2-1) to (2-3), the control section compares information capable of being inputted by the input section with the information memorized in the memory section in order to judge which one is new, and when the control section judges that the information capable of being inputted by the input section is new than the information memorized in the memory section, the control section renews the information memorized in the memory section.

(2-5) In the electronic appliance of (2-4), when the control section renews the information memorized in the memory section, the control section adds and records the information capable of being inputted by the input section in the information memorized in the memory section.

(2-6) In the electronic appliance of (2-4) or (2-5), the control section conducts the judgment on the basis of at least one of a renewal date and version information included in the information.

(2-7) In the electronic appliance of (2-3), the control section conducts authentication with the external device or with the predetermined recording medium before the inputting section inputs the information, and only when the control section confirms the authentication, the control section controls the input section to input the information from the external device or the predetermined recording medium.

(2-8) In the electronic appliance of one of (2-1) to (2-7), the output section outputs the information based on an operation to turn on or off a power source of the electronic appliance.

(2-9) In the electronic appliance of one of (2-1) to (2-7), the output section outputs the information for a predetermined time period.

(2-10) In the electronic appliance of one of (2-1) to (2-9), the one of the right and the certification given from the predetermined public organization is an intellectual property given from a Patent Office.

(2-11) In the electronic appliance of (2-10), the information includes information regarding a country in which an application was filed and the control section controls the output section to output the information regarding the country.

(2-12) In the electronic appliance of (2-10) or (2-11), the electronic appliance further comprises:

an eliminating section to eliminate the information memorized in the memory section; or

an prohibit section to prohibit the output section to output the information memorized in the memory section.

(2-13) In the electronic appliance of (2-12), the electronic appliance further comprises:

a calendar section having data of a date, wherein the control section judged whether an expiration date of the intellectual property has passed over or not based on the data of a date, and when the expiration date of the intellectual property has passed over, the control section controls the eliminating section so as to eliminate the information and/or the prohibit section so as to prohibit the output section to output the information.

(2-14) A system, comprises:

a transmitting terminal to transmit information regarding at least one of a right and a certification given from a predetermined public organization to a network; and

a receiving terminal to receive the information through the network, the receiving terminal having

a communicating section to receive the information,

a memory section to memorize the information received by the communicating section;

an output section to output the information memorized in the memory section as information concerning the receiving terminal; and

a control section to control the communicating section, the memory section and the output section,

wherein the control section renews the information stored in the memory section.

(2-15) In the system of (2-14), the output section is at least one of a display section to display the information and a printing section to print the information.

(2-16) In the system of (2-14) or (2-15), the control section judges whether or not conducting renewing the information on the basis of at least one of a renewal date and version information included in the information memorized in the memory section.

(2-17) In the system of one of (2-14) to (2-16), the control section conducts authentication between the transmitting terminal and the receiving terminal before the transmitting terminal transmits the information, and when the control section confirms the authentication, the transmitting terminal transmits the information and the receiving terminal receives the information.

(2-18) In the system of one of (2-14) to (2-17), the one of the right and the certification given from the predetermined public organization is an intellectual property right given from a Patent Office.

(2-19) A program executed by an electronic appliance, comprises:

a receiving function to receive information regarding at least one of a right and a certification given from a predetermined public organization;

a memory function to memorize the information inputted by the receiving section;

an output function to output the information memorized in the memory section as information concerning the electronic appliance; and

a renewing function to renew the memorized information.

(2-20) In the program of (2-19), wherein the program further comprises a judging function to judge whether or not conducting renewing the information on the basis of at least one of a renewal date and version information included in the information memorized in the memory section.

(2-21) In the program of (2-19) or (2-20), wherein authentication is conducted for a transmitting source to transmit the information before receiving the information, and when the authentication is confirmed, the receiving function receives the information.

(2-22) In the program of (2-19) or (2-21), wherein the one of the right and the certification given from the predetermined public organization is an intellectual property right given from a Patent Office.

### BRIEF DESCRIPTION OF THE DRAWINGS

FIG. 1 is a block diagram of a camera.

FIG. 2 is a flow chart of the camera.

FIG. 3 is a flow chart of the camera.

FIG. 4 is a flow chart of the camera.

FIGS. 5(A) to 5(D) each is a view of a display means.

FIG. 6 is a view of a system using the network.

FIG. 7 is a flow chart in the system using the network.

FIG. 8 is a flow chart in the system using the network.

FIG. 9 is a flow chart in the system using the network.

### DETAILED DESCRIPTION OF THE PREFERRED EMBODIMENT

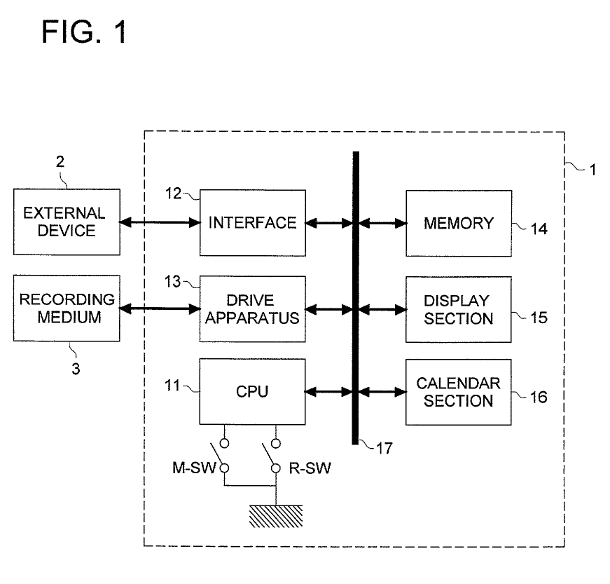

Referring to FIG. 1 to FIG. 9, embodiments according to the present invention will be described below.

In the following example, as an example of electronic appliances, a camera will be described. In this connection, as the camera, not only the camera using silver halide film, but also a digital camera or video camera may be used. Further, in the following, [a predetermined public organization] is the patent office, and [the right and certification given by the predetermined public organization] will be described as an example of the intellectual property, specifically, the industrial property such as the patent right. Further, hereinafter, [the information about the right and certification given by the predetermined public organization] is the information about the patent right, and specifically, it will be described as an application country code corresponding to the application country, patent number, filing date, the term of right, display flag determining whether it is displayed on a display means 15, which will be described later, data renewal date at which the data is inputted and renewed, or version information of the data, or password related properly to individual product, In this connection, [the information about the right and certification given by the predetermined public organization] will be called hereinafter the certification data.

Initially, a block diagram of the camera shown in FIG. 1 will be described below.

In FIG. 1, numeral 1 is a camera, and a CPU 11 inside the camera 1 conducts the control such as the storing or transferring of the certification data inside the camera 1.

Numeral 2 is a personal computer or server as an external device, and which has the communication function and is structured so that it can be connected to an interface circuit 12 through a communication cable 18.

Numeral 14 is a memory inside the camera 1 structured by a Flash EPROM or EEPROM.

Further, numeral 15 is a display section such as a liquid crystal panel display as a display means, and is arranged on the upper surface or rear surface of a main body outer package, and is structured so that the certification data and the other data such as the exposed frame number photographed by the camera 1 can be simultaneously displayed, the certification data being displayed as information concerning this camera (an electronic appliance).

Then, the CPU 11 takes in the certification data in the camera 1 from the external device 2 through the interface 12 having the communication function, stores it in the memory 14, and displays the certification data on the display section 15.

Further, the CPU 11 can not only input the certification data about the intellectual property in the production process or a service center through the external device 2, but also renew it.

Herein, the external device 2 may also be a device which can input or renew the certification data through a telephone line or a private line from the other host computer or server on the internet. Further, the external device 2 may also be a device which can input or renew the certification data through a private line from the host computer or server connected to a LAN.

In this connection, the communication of the camera 1 to the external device 2, or the external device 2 to the other host computer or server on the network, is not limited to the communication by the above communication cable, but may also be a communication by the wireless communication such as Bluetooth.

Numeral 3 is a recording medium such as an IC card, optical disk such as CD-ROM, magnetic disk, or optical-magnetic disk, and it is structured so that it can be installed into the camera 1. Then, even when the communication can not be conducted in such a case where the external device 2 and the camera 1 are not connected to each other with the cable, the certification data is recorded in the recording medium 3, and by installing the recording medium 3, the certification data about the intellectual property can be stored in the memory 14 through a drive 13 constituting a reading means in the present invention.

Further, numeral 16 is a calendar section constituting a calendar means, and has the year, month, day data and stores the date of the present time point.

A M-SW is a main switch and an R-SW is a release switch.

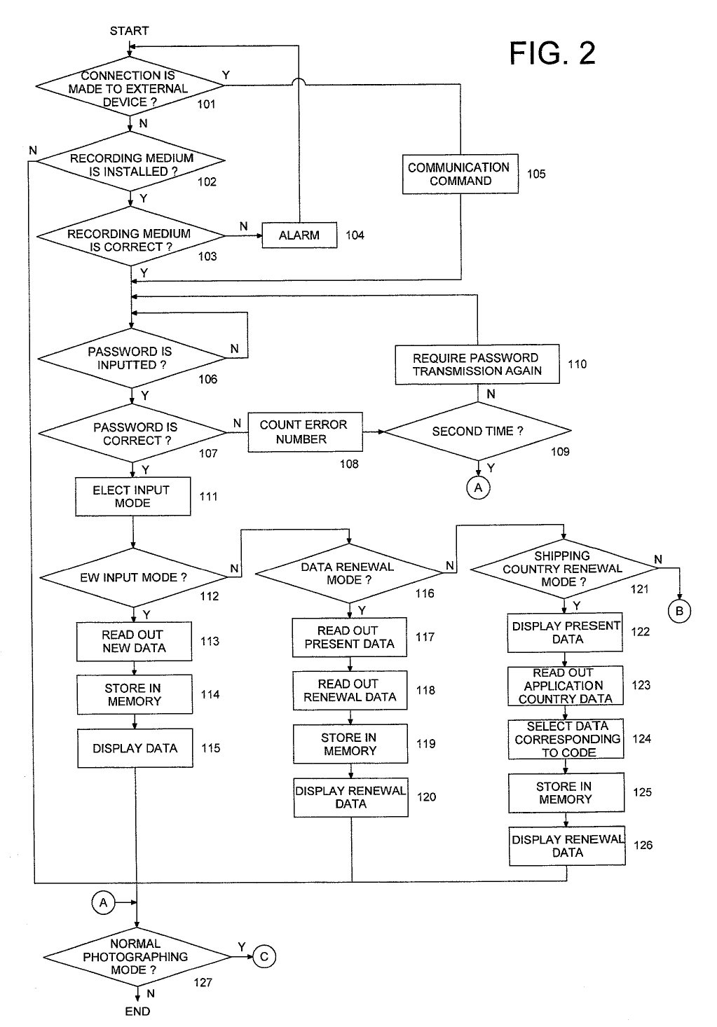

Next, referring to flow charts in FIG. 2 to FIG. 4, the present embodiment will be described. In this connection, numerals written in each block in the drawing show steps, and in the following description, numerals in ( ) correspond to steps in each flow chart.

The flow in FIG. 2 starts by detecting the installation of a battery into the camera 1 by a detecting means, not shown.

Initially, the CPU 11 judges whether the interface 12 in the camera 1 and the external device 2 are connected to each other with the cable 18, that is, whether the communication can be conducted (101). When the camera 1 is connected to the external device 2 (Y in 101), after the command such as the communication certification is sent and/or received to/from the external device 2 (105), it advances to step 106 which will be described later.

On the one hand, when the external device 2 is not connected (N in 101), the CPU 11 judges whether the recording medium 3 is installed into the camera 1, and when it is not installed (N in 102), further it judges whether the ordinary photographic mode is selected by the user. When the ordinary photographic mode is selected (Y in 127), the sequence advances to a sign C in the drawing, however, when the ordinary photographic mode is not selected (N in 127), after a predetermined end processing is conducted, the input renewal flow is completed.

When the recording medium 3 is installed in the camera 1 (Y in 102), the camera 1 judges whether the installed recording medium 3 is the recording medium 3 used for the general photography, or the recording medium 3 for the certification data input in which the certification data is recorded, which will be described later, and when it is not the recording medium 3 for the certification data input (N in 103), the camera alarms to the user to install the recording medium 3 for the certification data input (104).

When the recording medium 3 for the certification data input is installed (Y in 103), or the correspondence of the command of the communication permission with the external device 2 (105) is conducted, next, the camera 1 is in the waiting condition for reception of the password from the external device 2 (N in 106). This password is previously set for each camera between the external device 2 and the camera 1, or between the recording medium 3 for the certification data input and the camera 1, and in the camera 1, it is written in the re-writable memory such as EEPROM inside the camera together with each kind of adjustment data such as AF data, when the adjustment is conducted.

The password is transmitted from the external device 2 or the recording medium 3 for the certification data input to the camera 1, and the camera 1 receives the password (Y in 106), and collates the password stored in the camera 1 with the received password (107), as the result of the collation, when it is judged that the password is the previously set correct password (Y in 107), an input mode is set (111).

In this connection, in this step 106, when the password is not received even after a predetermined time period, it is preferable that the system is structured such that the sequence forcibly goes out of this flow and advances to step 127.

On the one hand, when the password is wrong (N in 107), the number of time of the false of the password is counted by a count means, not shown (108). Succeedingly, the camera 1 judges whether the number of times of the false of the password is the second time (109), when the false of the password is yet the first time (N in 109), the camera 1 requires, to the external device 2 or the recording medium for the certification data input, the re-sending of the password (110), and returns to the waiting condition for the reception of the password (N in 106). As structured in this manner, the condition in which, although the password itself is correct, the judgement is failed by an irregular error such as the transmission error of the password, can be avoided. In this connection, herein, although the allowance time of the false of password is two times, the present invention is not limited to this, and it is of course that the appropriate number of times may be set corresponding to the conditions of the user or maker.

Further, when the false of the password is the second time (Y in 109), the input or renewal of the certification data is not conducted, and the sequence advances to a sign A in the drawing.

As described above, the security function is increased and the reliability of the displayed certification data is increased by structuring the system in such a manner that the input of the password is conducted before the input or renewal of the certification data, and the data is not erased carelessly, or the certification data is not arbitrarily altered.

Further, because the password is a proper one set for each individual camera, when the camera 1 in which the input or renewal of the certification data is not scheduled, is connected to the external device 2 or the recording medium 3 for the certification data input, because the password error occurs, the system is protected so that the certification data is not falsely inputted or renewed to the camera 1 in which the input or renewal of the certification data is not scheduled.

In this connection, in the above description, the camera 1 receives the password inputted into the external device 2 or recording medium 3, and in the CPU 11, the password is collated with the password stored in the camera 1, however, the system may also be structured in such a manner that the password is not stored in the camera 1, and the password is inputted by using a operation member (not shown) such as numeral keys, and it is collated with the received password.

Further, herein, the password is transmitted from the external device 2 or recording medium 3 to the camera 1, however, it may also be structured in such a manner that the password is transmitted from the camera side 1 to the external device 2 or recording medium 3, as will be described later.

Further, these procedures are conducted at the timing at which the battery installation in the camera 1 is detected, however, it may also be conducted at the other timing.

When it is returned to the description of the flow, after the input mode is set at step 111, when the certification data is not inputted at all to the camera 1, the sequence becomes the new input mode (Y in 112), and the certification data is read from the external device 2 or recording medium 3, and taken in the camera 1 (113).

In this connection, in the present embodiment, the system is structured such that, when no certification data is inputted into the camera 1, the system becomes the new input mode, however, it is not limited to this, and it may also be allowable that, for example, a predetermined content instead of the certification data is inputted as the default data, and when it is judged that the default data is inputted, the system becomes the new input mode.

Herein, an example of the certification data written in the memory 14 will be shown in Table 1.

TABLE 1

| | Appli- | | | | | | |
|---|---|---|---|---|---|---|---|
| | cation | | | | Dis- | | |
| | country | | Filing | Term of | play | Renewal | |
| No | code | Patent No | date | right | flag | date | VER |
| 1 | JP | JPNo.1234567 | 1995.10.15 | 20 years | 1 | 2000.12.25 | 1.1 |
| 2 | US | USP2345678 | 1996.08.01 | 20 years | 0 | 2000.12.25 | 1.1 |
| 3 | DE | DE1357913 | 1996.08.15 | 20 years | 0 | 2000.12.25 | 1.1 |
| 4 | JP | PAT. PENDING | 2000.11.01 | 20 years | 1 | 2000.12.25 | 1.1 |

In this connection, [on the patent application] is expressed by [PAT. PENDING]. Further, the display flag 1 shows that it is displayed on the display section 15, and the display flag 0 shows that it is inhibited to display on the display section 15.

Further, other than the certification data in Table 1, as the data recorded in the memory 14, there is the password described above, and further, a maker ID showing the maker which produced the electronic appliance, or product proper ID properly provided to individual product, is recorded. The system may also be structured in such a manner that the maker ID or product proper ID is simultaneously written in the rewritable memory at the time of adjustment of AF data in the same manner as in the case of password. An example of the form in which these data are written, will be shown in Table 2.

[Table 2]

PASSWORD: ABCDXXXX

MAKER ID: KON777

PRODUCT PROPER ID: CAME007

Further, it is not always necessary to store all of these data, and for example, when the product is produced only in Japan, and brought into only the Japanese market, it is possible that the application country code is made not necessary.

Further, when these data are recorded in the recording medium 3, and read in the electronic appliance when it is installed in the electronic appliance, the external device 2 for inputting is not necessary, and the input and renewal of the data can be conducted by the simple operation. Particularly, in the area in which the external device 2 for input or communication means is not equipped, it is very convenient that the input renewal of the certification data is made possible from the recording medium 3. Then, these data are stored in the memory 14 (114) and displayed on the display portion 15 (115), and the sequence advances to step 127.

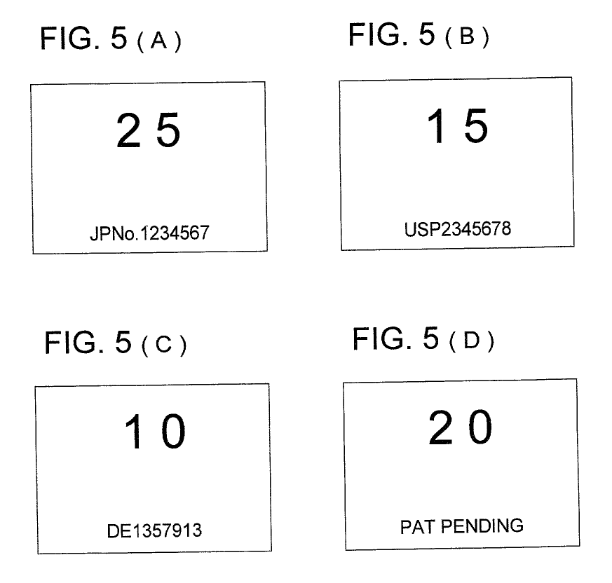

FIG. 5 is an example of the display of the certification data onto the display section 15, and the certification data showing that FIG. 5(A) is a Japanese patent, FIG. 5(B) is USP, FIG. 5 (C) is a Germany patent, and FIG. 5 (D) is patent pending, is displayed. In this example, together with the certification data, the number of exposed frames photographed by the camera 1 or the photographing frame number are made simultaneously displayed, and in each drawing, the photographing frame number is written by a numeral larger than the character • numeral showing the certification data.

In this connection, when there are a plurality of certification data in the same application country, for example, when there are a plurality of techniques, which are patent pending, adopted in the camera 1 which is in the Japanese market, when the display section 15 is a size which can simultaneously display all of the plurality of the patent information, the system may be structured such that it simultaneously display all of the plurality of the patent information. On the one hand, when the display section 15 is a size which can not simultaneously display all of the plurality of the patent information, the system may also be structured such that the plurality of patent information are successively switched and displayed, by a predetermined operation by using the operation keys, not shown.

Further, as the displayed patent information, other than the number such as the patent number, the filing date, term of the right, due date of the right, renewal date of the data, and version information of the certification data, may also be displayed with together.

Next, there is a case where the data about the inputted intellectual property is renewed. This is the case where the patent on filing is registered, application is changed, the patent is the divisional application, or the patent is the foreign application. In this case, it is a data renewal mode (Y in 116), present data is displayed on the display section 15 (117), succeedingly, the data to be renewed is read from the external device 2 or recording medium 3 and taken in the camera 1 (118), stored in the memory 14 (119), and the renewed data is displayed on the display section 15 (120), and the sequence advances to step 127.

Further, there is a case in which, according to the change of the sales condition, the country to be shipped of the camera which is stocked in the warehouse, is changed. In this case, it is the destination country change mode (Y in 121), and the present data is displayed on the display section 15 (122), the application country code (shown in Table 1) corresponding to the application country is read from the external device 2 or recording medium 3, and taken in the camera 1 (123). That is, by inputting the destination country into the camera 1, the CPU 11 selects the data about the intellectual property of the application country corresponding to the destination country according to the application country code (124), stored in the memory 14 (125), the data corresponding to the destination country is displayed on the display section 15 (126), and the sequence advances to step 127.

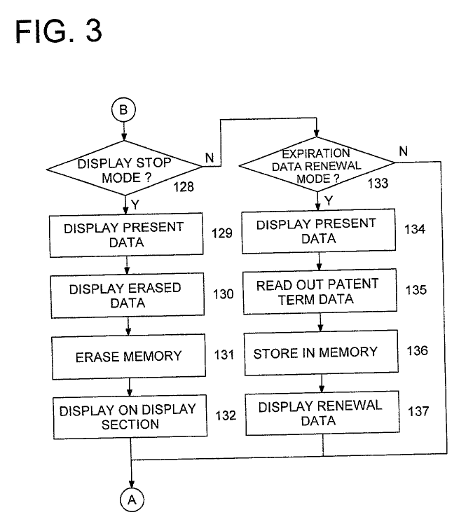

Further, there is a case where the shipment is made to the country to which the patent application is not made, according to the change of the sales condition, the patent is not registered on its filling due to the related art, or the patent application is withdrawn, according to the condition of the applicant himself. In such the case, it is preferable that at least the display on the display section 15 is stopped. Accordingly, it is a display stop mode (Y in 128) in FIG. 3, the present data is displayed on the display section 15 (129), the data to be erased is read from the external device 2 or recording medium 3, and taken in the camera (130), and eliminated from the memory 14 (131). Then, the display showing the elimination completion is conducted on the display section 15 (132), and after it is made so that the visual confirmation can be conducted, the sequence advances to a sign A in the drawing.

In this connection, in step 131, the sequence may be structured such that the elimination data is not eliminated, and the display flag is only changed from 1 to 0, and it is stored again as the data for which the display is inhibited. Relating to this, it will be described later.

Further, normally, the filing date of the patent application or term of the patent right is inputted in the new input mode (Y in 112), however, according to the condition, there is a case in which this is not inputted. Further, there is also a case in which, according to the amendment of the low about the intellectual property such as the patent law, the term of the patent is changed. In such the case, the sequence is the due date renewal mode (Y in 133).

Initially, the present data is displayed on the display section (134), and the data about the amended term of the patent right is read from the external device 2 or recording medium 3 and taken in the camera 1 (134), stored in the memory 14 (136), and the renewed data is displayed on the display section 15 (137). Then, the sequence advances to the sign A in the drawing.

Further, when it is not also the due date renewal mode, that is, when it is not any mode of the above description (N in 133), the sequence advances to the sign A in the drawing.

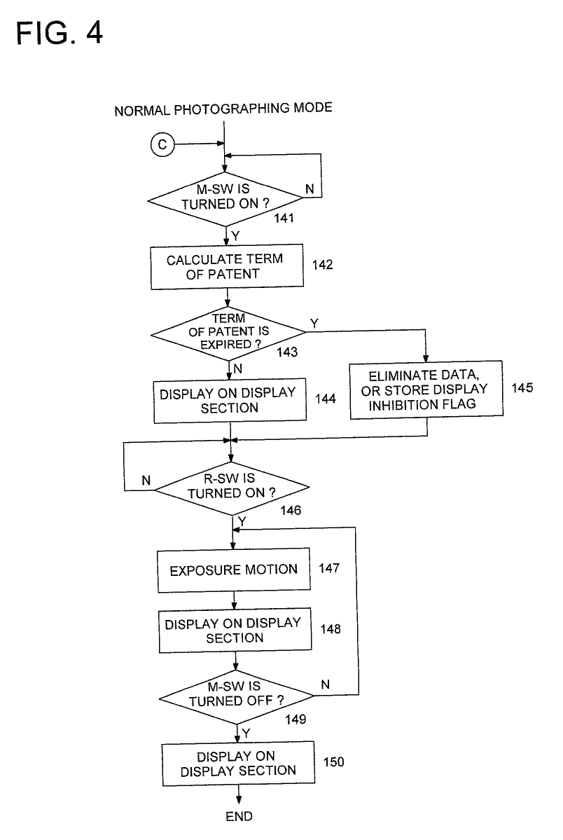

FIG. 4 is a flow chart when the normal photographing mode is selected by the user. When it is detected that the main switch M-SW is ON (Y in 141), the filling date and the due date of the patent right are read from the memory 14 for each certification data about the intellectual property, and in the CPU 11, the scheduled date of the due date of the patent right is calculated and obtained (142). That is, in Japan, because the due date of the patent right is 20 years from the filling date, according to the filling date and the term of 20 years, the due date of the patent right can be obtained.

Then, according to this calculation result and the year, month, day data which the camera has, it is judged whether the term of the right is terminated at the present time (143). when the term of the right is not terminated (N in 143), on the display section 15, only the information about the patent data in which the flag of the display inhibition (the display flag is 0) is not set in the memory 14, is displayed, for example, for 10 seconds (144). In this connection, in the present embodiment, after the certification data is displayed for the predetermined time (10 seconds), the display is stopped, however, this is not limited to the above description, but, it may be structured such that the certification data is continuously displayed.

Further, this display is displayed not only under the main switch M-SW is ON, but it may also be structured so that it is displayed under the both conditions of ON and OFF, or it may also be structured so as to be displayed only under the condition of OFF. In this connection, when the display is conducted under the condition that the main switch M-SW is OFF, the display is conducted by using the backup power source.

When the present date is over the expiration scheduled date of the term of patent (Y in 143), the data about the corresponding intellectual property is eliminated from the memory 14, or the display flag is changed from 1 to 0, and stored again (145). Then, in the renewal data of the certification data, the year, month, and day of the present point is recorded as the renewal date, and the numeral of the version information (VER) is increased, and stored as the newest data. According to this, from the next time, even when the main switch M-SW is turned ON, the certification data whose term of the right is terminated, is not displayed.

In this connection, when the term of the right is terminated, the certification data is not eliminated, and when the display flag is changed from 1 to 0, because the display can be conducted again at need, it is preferable. In this connection, the calculation (142) whether the term of the right is terminated, may be conducted for each shutter release.

Herein, the renewal of the certification data will be described below.

TABLE 3

| | Appli- | | | | | | |
|---|---|---|---|---|---|---|---|
| | cation | | | | Dis- | | |
| | country | | Filing | Term of | play | Renewal | |
| No | code | Patent No | date | right | flag | date | VER |
| 1 | JP | JPNo.1234567 | 1995.10.15 | 20 years | 1 | 2000.12.25 | 1.1 |
| 2 | US | USP2345678 | 1996.08.01 | 20 years | 0 | 2000.12.25 | 1.1 |
| 3 | DE | DE1357913 | 1996.08.15 | 20 years | 0 | 2000.12.25 | 1.1 |
| 4 | JP | JPNO.987654 | 2000.11.01 | 20 years | 1 | 2003.04.01 | 1.2 |

Table 3 is the data in which the data of the Table 1 is renewed.

In FIG. 1, the data number 4 (NO. 4) is on the patent pending, however, because it is registered as the time elapses, the data of an item of the [patent number], [renewal date], and the data of [version information item (VER)] are renewed.

Herein, in the Table 3, the data number 4 of the Table 1 is overwritten and saved, and the past data is eliminated, and it may also be allowable that, as in the Table 4, it is not overwritten and saved, and all the data from the date at which the past information is initially recorded, to the present date, is left as the history.

TABLE 4

| | Appli- | | | | | | |
|---|---|---|---|---|---|---|---|
| | cation | | | | Dis- | | |
| | country | | Filing | Term of | play | Renewal | |
| No | code | Patent No | date | right | flag | date | VER |
| 1 | JP | JPNo.1234567 | 1995.10.15 | 20 years | 1 | 2000.12.25 | 1.1 |
| 2 | US | USP2345678 | 1996.08.01 | 20 years | 0 | 2000.12.25 | 1.1 |
| 3 | DE | DE1357913 | 1996.08.15 | 20 years | 0 | 2000.12.25 | 1.1 |
| 4 | JP | PAT. PENDING | 2000.11.01 | 20 years | 1 | 2000.12.25 | 1.1 |
| 1 | JP | JPNo.1234567 | 1995.10.15 | 20 years | 0 | 2002.06.01 | 1.2 |
| 4 | JP | JPNO.987654 | 2000.11.01 | 20 years | 1 | 2003.04.01 | 1.2 |

At the renewal date of Dec. 25, 2000, the content of Table 4 is originally stored as in the content of Table 1, however, in the patent of the data number 1, because its right is eliminated by a reason such as the waiver of the right, the display flag is changed to 0 for stopping the display at the renewal data of Jun. 1, 2002. Further, also out the patent of the data number 4, at the time point of Dec. 25, 2000, it is on [PAT. PENDING], and the registration number is given to it, and it is renewed to [JPNO. 987654].

According to this, even when the renewal date and the version information (VER) are renewed, because it is addition-stored while the past data is left, and the past data remains as the history, the history can be read on the display section 15 or the monitor of the external device 2 and confirmed later at need. In this connection, in the case where it is not necessary that the history is confirmed even in this case, when the data of the same data number exists, by displaying the newest version information or the newest renewal date, it can be avoided that the old data is displayed, thereby, the confusion occurs.

Further, when the system is structured such that the content of history of the data renewal date or version information is outputted to the display section of the camera 1, external device 2 or recording medium 3 and can be read, by a specific operation, it can be judged whether the change of the data is necessary.

That is, the data renewal date or version information stored in the memory 14 is compared to the newest data renewal date or version information provided by the external device 2 and the recording medium 3, and only when the newest data renewal date or version information provided by the external device 2 and the recording medium 3 is newer than the data renewal date or version information stored in the memory 14, the certification data stored in the memory 14 is renewed, and on the one hand, in the case where both are the same, when it is displayed that the renewal of the certification data stored in the memory 14 is not necessary, or the renewal operation is not compulsively conducted, it is not necessary that useless data accompanied by the renewal operation is transferred. Such the judgement can be conducted after the step 118 in FIG. 2.

Further, all of the past history content is not recorded, but, only the change of a predetermined content may be left. For example, the number given to the patent application changes with the lapse of time, from [application number], [public inspection number], to [registration number], however, even the case where these numbers are respectively renewed and displayed, the data according to [application number] and [registration number] is left, but, in the case where the necessity that the data according to the [public inspection number] is left as the history data, is low, at the renewal time from the [application number] to [public inspection number], the data according to the [application number] is left, and on the one hand, at the renewal tine from the [public inspection number] to the [registration number], the data according to the [public inspection number] is saved so as to be overwritten by the data according to the [registration number]. According to this, it can be avoided that the memory 14 is uselessly used by the unnecessary data.

Further, when these renewal operation is conducted, it is preferable that the password is confirmed without fail, thereby the security function is increased.

When returned to the description of FIG. 4, succeedingly, when the release button is pressed and the release witch R-SW is tuned ON (Y in 146), the exposure operation is conducted (147), and the certification data is displayed on the display section 15 for 10 seconds (148). Of course, when the certification data is eliminated, or it is not inputted form the fist, the certification data is not displayed.

After that, also when the main switch M-SW is turned OFF (Y in 149), after the certification data is displayed for 10 seconds on the display section 15 (150), the predetermined processing is conducted, and the normal photographing mode is completed. Further, when the main switch M-SW is not turned OFF (N in 149), the sequence returns to the judgment step (146) whether the release switch R-SW is turned ON.

In the above description, the application date and the expiration of the term of the patent right are read and the expiration scheduled date of the term of patent is calculated, however, the system is not limited to this, but it may also be structured such that the previously found expiration scheduled date of the term of patent is stored in the external device 2 or recording medium 3, and the expiration scheduled date of the term of patent is read from the external device 2 or recording medium 3, and by referring to year, month, date data, it is judged whether the term of the patent right is terminated at the present time. According to this, it is not necessary that the expiration scheduled date of the term of patent is calculated every time.

Further, by using the year, month, day data of the calendar section 16, according to the present date, application date and expiration scheduled date of the term of patent, or the present date and the expiration scheduled date of the term of patent, the number of days from the present date to the expiration scheduled date of the term of patent may also be obtained by the calculation.

The flow described above is the base of the present invention, and each mode as the following is considered, and these modes are included on the present concept.

The electronic appliance is, of course, the optical device other than the camera, the domestic electric device, OA device, IT device, medical device, measuring device, machine tool, or toy, and when it is an electronic appliance which can structure a block diagram as shown in FIG. 1, any device may be allowable. In this connection, in the case of a device other than the camera, because it has no release switch R-SW, [the release switch R-SW] in the present specification is replaced for reading with [a predetermined switch to operate the electronic appliance].

Further, the electronic appliance which does not have the display section, but has a print means provided with a print section to print on the sheet, may also output the certification data about the intellectual property by printing.

As the certification data about the intellectual property, it is not limited to the information relating to the patent right, but, of course, it may also be the utility model right, design patent right, or trademark right. Further, as the information about the right or certification provided from a predetermined public organization, each kind of authorization number, or each kind of approval number given from each kind of public organization such as the ministry of Health, Labour and Warfare, or JIS, UL, FDA is also be allowable. In this connection, the organization may also be an organization other than the public organization, for example, the third-party organization which is on commission from the public organization such as the country or self-governing body, and the outside organization of the public organization are also included in the concept of the [public organization].

Further, when the display of the country of origin is obligated, the name of the country of origin may also be the display data. In this case, when the production places are over a plurality of countries, the name of country of origin may be appropriately displayed corresponding to the content of production.

Relating to the input of the information about the right or certification given from a predetermined public organization, the external device or recording medium is not used, and when a special operation different from the normal operation is conducted, the operation of the operation member of the electronic appliance is made to be an input mode of the corresponding information, and the corresponding information may also be able to be inputted by using the operation member (for example, numeral key) for date setting/correction. In this connection, the special operation different from the normal operation means that, for example, two operation members between which there is a low relation, are simultaneously operated, and as an example, a simultaneous operation of a main switch and a film rewinding switch can be cited. Further, the corresponding information my be inputted into the electronic appliance not by the operation member of the electronic appliance, but by the input means of the sound or character, or bar code optical reading means. In this connection, as in the case of the copier or printer described above, relating to the electronic appliance for which the service man periodically conducts the check, it is preferable that the certification data is renewed for each time by using the recording medium 3.

Further, the display onto the display section 15 may also be always conducted, or it may also be conducted just after a predetermined operation or timing, or after its predetermined time period. Further, it may also be displayed when the main switch M-SW is turned ON, or OFF. The longer the display time is, the more the display times are, the more preferable because the user can be made to recognize it, however, on the one hand, when the display time is long, because the electric power (or battery) is consumed, it is preferable that the display time or the number of display times can be appropriately set by the user.

Further, it is preferable that the selection of each mode for the input or renewal of the certification data described above has the user interface function by which the operator can easily select and can easily confirm it, from the menu image plane of the camera main body or the monitor of the connected external device.

Further, when the main switch M-SW is turned OFF, the display of the battery remaining amount may also be conducted simultaneously. Further, when the battery of the electronic appliance 1 is exchanged, it is preferable that the operation is conducted by the backup battery so that the data stored in the memory 14 does not disappear, or the data is temporarily stored in the EEPROM. Further, it may be allowable that when the main switch M-SW is turned OFF, the certification data is back-up recorded in the installed recording medium 3, and when the main switch M-SW is turned ON again, it is read by the electronic appliance 1. Thereby, the buck-up power source is not necessary.

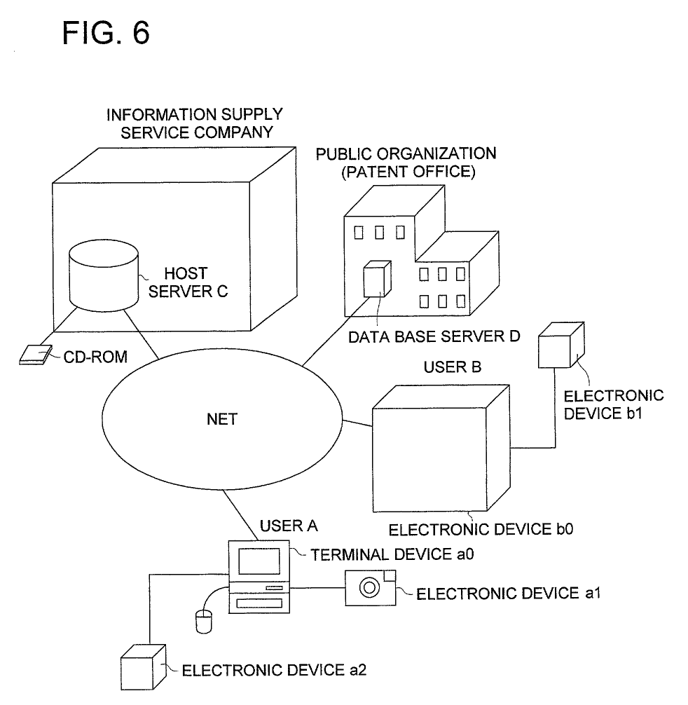

Further, when the server which can be connected to the public organization through the network such as the internet, is connected to the electronic appliance, the system may be structured such that the newest certification data of the patent information is accumulated in the server, and every time when the main switch M-SW of the electronic appliance is tuned ON, the newest certification data is obtained from the server. Referring to the schematic view of the system using the network in FIG. 6, this case will be described below.

In this connection, hereinafter, [the information about the right or certification given from a predetermined public organization] will be described in an example of [the information about the patent application], however, the present invention is not limited to this. In the drawing, NET is a network WAN represented by the internet, and the data base server D of the patent office as the public organization, and the host server C in which the information about the patent application is accumulated, are appropriately connected with each other through the LAN.

In the data base server D of the patent office, the data such as the patent registration number described above is accumulated, and the information such as the patent registration number or the change of status can be obtained, however, in the data base server D of the patent office, [the maker ID], [the renewal password], and [the product proper ID] included as the certification data are not recorded.

Because these information such as [the product proper ID] are necessary information at the time of the certification data renewal, the newest [information about the patent application] obtained from the data base server D of the patent office, and the information such as the [product proper ID] are necessary to be related. Accordingly, the host server C is, as an example, maintained and controlled by the information supply service company (hereinafter, simply called service company) to supply the patent application information, and after the newest patent information including the status and the product proper ID of the user as the customer, are related to each other, the patent information including the certification data of Table 1 (or Tables 2-3) is registered in the host server C. Further, not only the data of the host server C is provided through the network NET, but it may also be separately provided in the form of the recording medium 3 such as the CD-ROM, or IC card, and in this case, each electronic appliance can renew the newest patent information by using the recording medium 3. Further, the host server C is always connected to the network NET so that it can communicate always.

The user A is connected to the network NET by the communication terminal a0 composed of the computer or server, and the communication terminal a0 is structured such that, at least, it can transfer and receive the data between the host server of the service company. Further, the electronic appliances a1 and a2 owned by the user conduct the transferring and receiving of the data to the communication terminal a0 through the serial communication cable, wireless communication means such as Bluetooth, or LAN. In this connection, the user may directly connect the electronic appliance onto the network NET not though the communication terminal equipment such as the computer or server. Another user B has a large fixed type electronic appliance b1 provided with a communication function which is always connected to the network NET, and the electronic appliance b1 is structured such that, at least, it can conduct the transferring and receiving of the data between the host server C of the service company. Further, other than that, the electronic appliance b2 owned by the user B is structured such that it can conduct the transferring and receiving of the data to the electronic appliance b1 through the serial communication cable, wireless communication means such as Bluetooth, or LAN.

In the system structured as described above, the service company initially contracts individually the user as the customer, and relates the [maker ID] for distinguishing the customer, the [product proper ID] for relating the patent information to the product, and the patent information relating to the corresponding product (for example, the patent application number) to each other, and forms the data table, for example, as Table 1. In this case, simultaneously, the [renewal password] is determined, and registered in the host server C together with the [maker ID] and the [product proper ID]. As the result, the service company can determine unconditionally the relating patent information by the [maker ID] and the [product proper ID].

On the other hand, the user stores the [maker ID], [product proper ID], and [renewal password] in the memory means 14. In this connection, at the time of renewal, when the renewal password is inputted by using the operation key, it is not necessary that the [renewal password] is stored in the memory means 14.

Then, always or periodically, the service company makes access to the data base server D such as the patent office which is the public organization, for obtaining the newest information, according to the patent information (for example, the patent application number) registered in the host server C, and checks the change of the lapse, such as [whether the registration number is provided], or [whether the patent right is eliminated], and when there is the change, the content of the certification data such as, for example, in Table 1 is renewed to the newest information, and the renewal date and the version information are recorded.

Then, when the user A who has the maker ID registered in the host server C, or the user B makes access to the host server C under the condition in which the terminal device a0 to which the electronic appliances a1 or a2 is connected, or only the electronic appliance b0 or electronic appliance b1 is connected, and by the flow described in FIG. 2, the [maker ID], [product proper ID], and [renewal password] coincide, and according to the renewal date or version information, when it is judged that the patent information (certification data) stored in the product having the [product proper ID] is not the newest one, the newest patent information (certification data) is transmitted to each electronic appliance. Herein, when judged that it is the newest patent information, the host server C noted it to the user side, and because the more communication is not necessary, the load onto the communication is reduced.

Then, the user A is a small sized device such as the camera, and is controlled in the warehouse and in the electronic appliances a1 and a2 which are independent from the network N, the newest patent information is renewed through the terminal device a0, and further, for the user B which is a large sized fixed type electronic appliance b0, the newest patent information is directly renewed, and the electronic appliance b1 is renewed through the electronic appliance b0. In this connection, when the right such as, for example, the patent right disappears, or when the refusal of the patent application is decided, there is a case where it is better that the display of the patent information is stopped soon. The host server C of the service company makes access to the database server D of the patent office always or periodically, and for example, when it is detected that the refusal of the patent application which is adopted in the electronic appliance a2 of the user A is settled, in order to stop the display of the [PAT. PENDING] in the electronic appliance a2, it is desirable that, even in the case where there is no data renewal request from the terminal device a0 of the user A, the host server C of the service company transmit the information to urge the stop of the display to the electronic appliance a2 through the terminal device a0. In this case, when the electronic appliance a2 is not connected to the communication terminal device a0, the data for the renewal is sent to the terminal device a0, and next, when the electronic appliance a2 is connected to the terminal device a0, it may also be allowable that the display flag in the certification data of the electronic appliance a2 is rewritten to 0 by using the terminal device a0. That is, in this case, the terminal device a0 renews the patent information of the electronic appliance a2 in place of the host server C. In this case also, when the password confirmation is conducted between the terminal device a0 and the electronic appliance a2, the security is increased.

Further, when the terminal device a0 is not connected to the network NET always, therefore, the renewal of the certification data can not require instantly to the terminal device a0, the electronic mail is automatically transmitted to the terminal device a0 or its controller from the host server C, and it may also be communicated to it that the quick renewal is necessary.

When the service company records the newest patent information in the recording medium 3 such as the CD-ROM, IC card, or magnetic recording, and distributes it to a predetermined user, it may also be allowable that it is recorded together with the system program relating to the electronic appliance, and distributed. According to this, the patent information can be recorded in the electronic appliance simultaneously with the install of the system program relating to the electronic appliance, and also for the electronic appliance delivered once to the user, when the recording medium 3 for the version-up of the software of the system program is distributed, the newest patent information can also be version-upped, which is convenient.

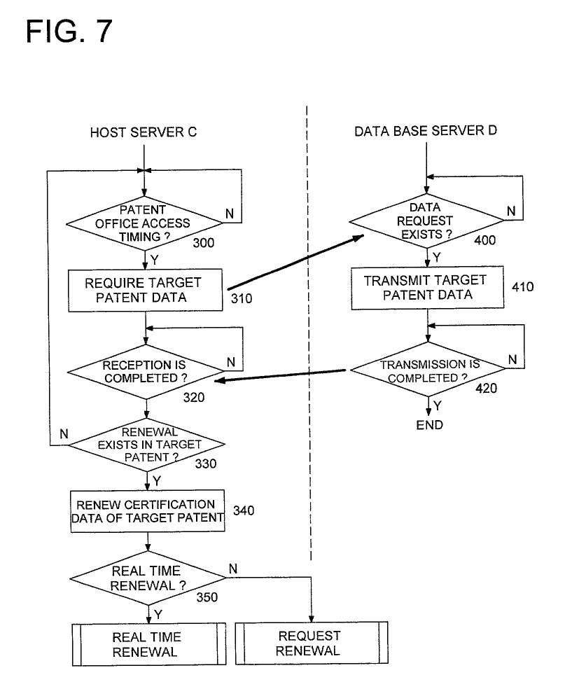

Referring to FIG. 7 to FIG. 9, another embodiment in the system using the network will be described below.

Also in this embodiment, the service company contracts with respective users beforehand, and it is presumed that, according to the [renewal password], [maker ID], [product proper ID], and related patent information, the data table as Table 1 is made already.

In the present embodiment, further, the timing at which the data is renewed, and a method to renew the data, are arranged beforehand with the user, and the patent information is renewed at the timing and by a method which are desired by the user. That is, the service company and the user decide beforehand that at which timing of [real time renewal]or [request renewal], the certification data is renewed, and relates it to the certification data in the host server C and store it. Herein, [the real time renewal] is the renewal which, there is the change of patent information such as the expiration of the right or the refusal settlement, and as soon as the certification data in the host server C is renewed, is conducted to the electronic appliance on the user side at the timing. Further, the [request renewal] is the renewal which, the access is made from the user side to the host server C, and at the timing at which the renewal is requested, is conducted to the electronic appliance on the user side.

Further, the service company and the user decide beforehand that the certification data is renewed by either method of the [on-line renewal] or the [offline renewal], and relate it to the certification data in the host server C and store it. Herein, the [on-line renewal] is the renewal which, when the device such as the terminal device a0 or electronic appliance b0 which is connected to the network NET, is connected always to the network NET so that the communication can always be conducted, is conducted to the electronic appliance on the user side. Further, the [off-line renewal] is the renewal which, when the device such as the terminal device a0 or electronic appliance b0 which is connected to the network NET, is connected to the network NET, at the timing or time specified by the user, and the communication is connected to the network NET, is conducted to the electronic appliance on the user side.

Referring to FIG. 7, the explanation will be conducted below.

In order to obtain the newest patent information, the host server C makes access to the data base server D of the patent office at a predetermined timing, and when it becomes a predetermined timing (Y in 300), the transmission of the data about the patent registered in the certification data is required to the data base server D (310). When there is the transmission request (400), the data base server D conducts the data transmission (410) for the requested patent, and when the transmission is completed (420), it returns to the waiting conditions. On the one hand, when the data reception is completed (320), the host server C judges whether there is a change in the patent information according to the data as in Table 1 (or Table 2, Table 3) stored in the host server C (330), and when there is no change, because the data renewal is not necessary, it returns to the waiting condition (N in 330).

On the one hand, when there is a change, the certification data of the corresponding patent is renewed (350), and then, judges whether the certification data is set by which one of the [real time renewal] or [request renewal] (350), and the processing according to respective renewal timing is conducted.

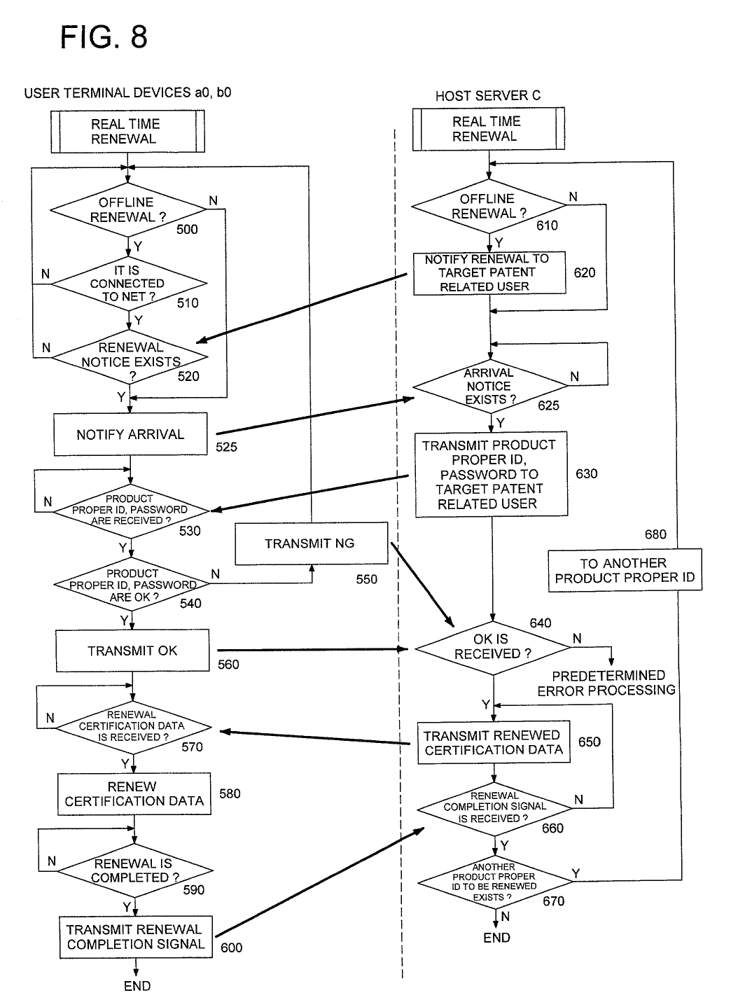

FIG. 8 is a flowchart when the [real time renewal] is set.

The host server C judges whether it is to be renewed by either one of the [offline renewal] or the [on-line renewal] (610), and when that is the [offline renewal], to the user who registers the renewed patent, the renewal notice to notify that the renewal is conducted, is conducted (620), and waits the arrival notice from the user side (625). In this case, the renewal notice may be conducted by using the electronic mail described in a predetermined format.

On the one hand, the terminal devices (a0, b0) on the user side of the device connected to the network NET, according to the content stored in the memory 14 in the in the terminal device, judge whether it is to be renewed by either one of the [offline renewal] or [on-line renewal] (500), and when that is the [on-line renewal], wait in the step 530, which will be described below. On the one hand, when that is the [offline renewal], the device monitors whether it is connected to the network NET (510), and when the terminal device is connected to the network NET, it checks whether there is a renewal notice from the host server C (520). When there is the renewal notice, it transmits the arrival notice to the host server C for the renewal notice (525).

The host server C which received (Y in 624) the arrival notice, transmits at least the [product ID], and [password] to the user side for the confirmation (630), and after these are received by the user terminal device (530), it is confirmed that these are correct or incorrect (540). When it can be confirmed that the password is correct, that effect is noticed (560), and on the one hand, when it can not be confirmed that the password is correct, it is noticed that the password can not be confirmed (550), and the host server C returns to a waiting condition.

According to the received result (640) of the confirmation, when the result is negative, the host server C conducts a predetermined error processing because there is a possibility that the registered [product proper ID] and [password] are incorrect, and when the positive result is obtained, it transmits the certification data in which the patent information is renewed (640).

When the user side terminal device receives the renewed certification data (570), according to the received data, the certification data stored in the memory 14 is renewed (580), and when the renewal is completed (590), the renewal completion signal is transmitted (860), and the device returns to a waiting condition.

On the one hand, when the host server C receives the renewal completion signal (660), it judges that the renewal is completed for the terminal device to which the transmission is conducted till now (Y in 660), and checks the existence of the product having another proper ID registered about the same patent (670), and when another ID exists, the renewal operation is repeated so that the certification data of the product having the proper ID is renewed (680), and when the renewal is completed for all the products for the patent (N in 670), the sequence goes out the routine.

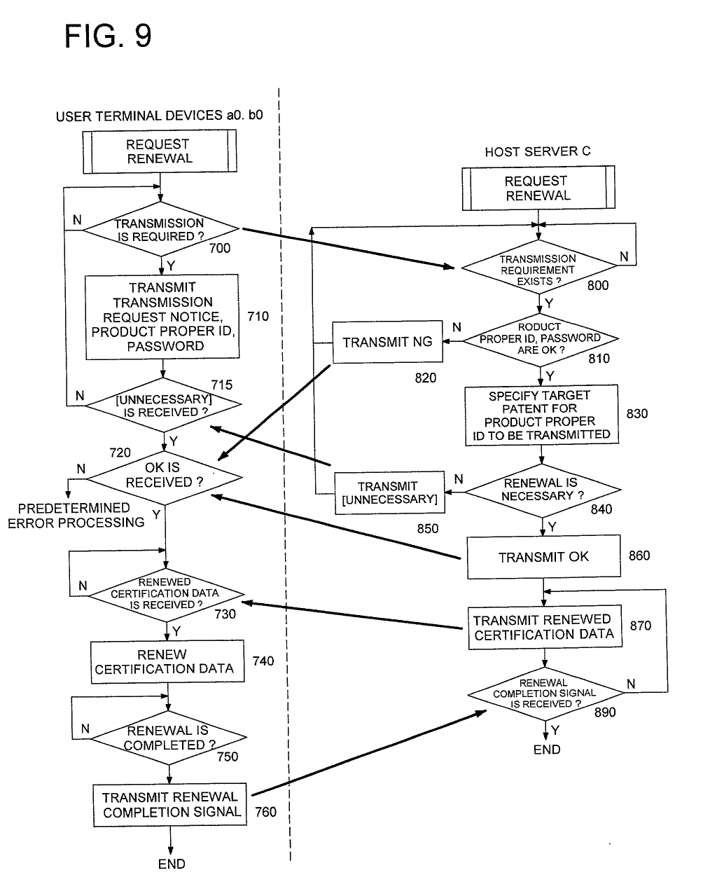

FIG. 9 is a flow chart when the [request renewal] is set. In the [request renewal], at the time point when the user terminal device requires the data renewal request to the host server C, because the user terminal device is connected to the network NET, it is not necessary to distinguish whether the transmission is conducted by the [on-line transmission] or the [offline transmission]. When the user terminal device requires the data renewal request from the waiting condition (700), it transmits the transmission request notice to require the renewal and the [product proper ID], [password] to the host server C (710).

On the one hand, on the host server C side, it is judged whether there is the transmission request notice from the user side (800), and when there is the transmission request notice, the host server C judges the correct or incorrect of the received [product proper ID], [password] (840), and when these are incorrect, it is noticed that the confirmation can not be obtained (820), and it returns to the waiting condition. When these are correct, it is judged whether the renewal of the certification data of the patent related to the [product proper ID] is necessary (840). When there is no change of the patent information, the renewal is not necessary, and the unnecessary communication can be avoided. Even when the renewal is not necessary (N in 840), it is noticed that the renewal is not necessary (850), and it returns to the waiting condition. When the step renewal described above is necessary (Y in 840), it is noticed that the renewal is started (860).

When the user terminal device receives the notice of the above-described step 850 (715), because the renewal is unnecessary, it returns to the waiting condition, and further, when the notice of the above-described step 820 is received, because there is a possibility that the [product proper ID], and [password] stored in the memory 14 are incorrect, a predetermined error processing is conducted. Then, only when the notice of the above-described step 860 is received, the sequence advances to the following step.

After the renewal start notice (860), the host server C transmits the certification data in which the patent information is renewed (870), and in the user terminal device, when the renewed certification data is received (730), according to the received data, the certification data stored in the memory 14 is renewed (740), and when the renewal is completed (750), it transmits the renewal completion signal (760), and ends.

On the one hand, when the renewal completion signal is received (890), the host server C ends the present routine.

In the above described example, the host server C is maintenance-controlled by the service company, but, it may also be maintenance-controlled by each user at need.

Further, in the above example, it is not always necessary that the patent information accumulated in the host server is in the form of Tables 1-3, and when it includes the data of the content by which the user side can finally form the certification data, any form may be allowable. Further, besides, when the camera 1 is a digital still camera, the information relating to the copyright is additionally recorded to respective photographed images, and every time when the photographed image is displayed, the information relating to the copyright can be displayed. In this case, the information relating to the copyright is written on the Exif-tag of the photographed image, and when the copyright is lapsed, the information is erased from the Exif-tag. In this connection, relating to the Exif-tag, it is written in detail in the term of [2.6. Tags] of [Digital Still Camera Image File Format Standard (Exchangeable image file format for Digital Still Camera: Exif) Version] (2.1 JEIDA-49-1998) of JAPAN ELECTRONIC INDUSTRY DEVELOPMENT ASSOCIATION STANDARD.

Finally, the correspondence of the term written in [claims] to the term written in [Mode for Carrying Out the Invention] will be described below.

As an example, the following is described: as [the fixed public organization], the patent office, and as [the right or admission given from the fixed public organization], the intellectual property, specifically, patent right. Further, [the information relating to the right or admission given from the fixed public organization] is the information relating to the patent right, and specifically, it is described as the application country code corresponding to the application country, patent number, filling date, term of the right, display flag, data renewal date at which the data is inputted and renewed or version information of the data, or password peculiarly related to respective products. Further, the [memory means] corresponds to the memory 14, and the [control means] corresponds to the CPU 11. The [input means] corresponds to the interface 12 as the [communication means] and the drive apparatus 13 as the [reading-in means], and [output means] corresponds to the display section 15 as the [display means] and printing section as the [printing means]. Then, the [calendar means] corresponds to the calendar means 16. Further, the [network] and the [transmission side external device] respectively correspond to the NET, and host server in FIG. 6, and the [reception side terminal device] corresponds to the terminal device a0 or electronic device b0 in FIG. 6.

According to the present invention, the data relating to the intellectual property can be easily displayed not to mention in the factory, even in the business office, and when the data relating to the intellectual property is changed, the renewed data can be easily displayed in place of the old data.

What is claimed is:

1. An electronic appliance, comprising:
an input section to input information regarding at least one of a right and a certification given from a predetermined public organization;
a memory section to memorize the information inputted by the input section;
an output section to output the information memorized in the memory section as information concerning the electronic appliance; and
a control section to control the input section, the memory section and the output section.

2. The electronic appliance of claim 1, wherein the output section is at least one of a display section to display the information and a printing section to print the information.

3. The electronic appliance of claim 1, wherein the input section is at least one of a communicating device to communicate with an external device and a reading device to read information recorded in a predetermined recording medium.

4. The electronic appliance of claim 1, wherein the control section renews the information memorized in the memory section.

5. The electronic appliance of claim 4, wherein the control section renews the information by adding and recording new information capable of being inputted by the input section.

6. The electronic appliance of claim 4, wherein the control section conducts judgment on the basis of at least one of a renewal date and version information included in the information memorized in the memory section.

7. The electronic appliance of claim 3, wherein the control section conducts authentication with the external device or with the predetermined recording medium before the inputting section inputs the information, and only when the control section confirms the authentication, the control section controls the input section to input the information from the external device or the predetermined recording medium.

8. The electronic appliance of claim 1, wherein the output section outputs the information based on an operation to turn on or off a power source of the electronic appliance.

9. The electronic appliance of claim 1, wherein the output section keeps on outputting the information for a predetermined time period.

10. The electronic appliance of claim 1, wherein the one of the right and the certification given from the predetermined public organization is an intellectual property right given from a Patent Office.

11. The electronic appliance of claim 1, wherein the information includes information regarding a country in which an application was filed and the control section controls the output section to output the information regarding the country.

12. The electronic appliance of claim 10, further comprising:
an eliminating section to eliminate the information memorized in the memory section; or
an prohibit section to prohibit the output section to output the information memorized in the memory section.

13. The electronic appliance of claim 1, wherein further comprising:
a calendar section having data of a date, wherein the control section judged whether an expiration date of the intellectual property has passed over or not based on the data of a date, and when the expiration date of the intellectual property has passed over, the control section controls the eliminating section so as to eliminate the information and/or the prohibit section so as to prohibit the output section to output the information.

14. A system, comprising:
a transmitting terminal to transmit information regarding at least one of a right and a certification given from a predetermined public organization to a network; and
a receiving terminal to receive the information through the network, the receiving terminal having
a communicating section to receive the information,
a memory section to memorize the information received by the communicating section;
an output section to output the information memorized in the memory section as information concerning the receiving terminal; and
a control section to control the communicating section, the memory section and the output section,
wherein the control section renews the information stored in the memory section.

15. The system of claim 14, wherein the output section is at least one of a display section to display the information and a printing section to print the information.

16. The system of claim 14, wherein the control section judges whether or not conducting renewing the information on the basis of at least one of a renewal date and version information included in the information memorized in the memory section.

17. The system of claim 14, wherein the control section conducts authentication between the transmitting terminal and the receiving terminal before the transmitting terminal transmits the information, and when the control section confirms the authentication, the transmitting terminal transmits the information and the receiving terminal receives the information.

18. The system of claim 14, wherein the one of the right and the certification given from the predetermined public organization is an intellectual property right given from a Patent Office.
